(19) United States
(12) Patent Application Publication
(10) Pub. No.: US 2022/0080817 A1
(43) Pub. Date: Mar. 17, 2022

(54) SOUND INSULATION STRUCTURE AND VEHICLE COMPONENT

(71) Applicant: TOYOTA JIDOSHA KABUSHIKI KAISHA, Toyota-shi Aichi-ken (JP)

(72) Inventor: Masayuki Okano, Toyota-shi Aichi-ken (JP)

(21) Appl. No.: 17/469,327

(22) Filed: Sep. 8, 2021

(30) Foreign Application Priority Data
Sep. 11, 2020 (JP) 2020-152506

(51) Int. Cl. B60J 10/75; B60J 10/50

(52) U.S. Cl. CPC B60J 10/75; B60J 10/34; B60J 10/50

(57) ABSTRACT

An inner belt line weather strip includes a body part to be attached to a door interior member of a vehicle and a plurality of protrusion disposed on a surface of the body part. The inner belt line weather strip is to be disposed in a space between the door interior member and a door glass, forming a propagation path of noise from outside a vehicle cabin to the vehicle cabin, to reduce transmission of noise through the space.

### CROSS REFERENCE TO RELATED APPLICATION

This application claims priority to Japanese Patent Application No. 2020-152506 filed on Sep. 11, 2020, which is incorporated herein by reference in its entirety including the specification, claims, drawings, and abstract.

### TECHNICAL FIELD

The present disclosure relates to a sound insulation structure that reduces noise transmission from outside a vehicle cabin to the vehicle cabin and to a structure of a vehicle component.

### BACKGROUND

Battery electric vehicles driven by a motor are widely used in recent years. The battery electric vehicles including no engines emit less noise than conventional vehicles driven by an engine. Therefore, the interior noise of a battery electric vehicle is mainly road noise between tires and a road surface or wind noise, of which the road noise may enter the vehicle cabin along a propagation path from below a vehicle door through an inner weather strip of a belt line of the vehicle. JP 2001-301469 A, for example, proposes a structure including a sound-absorbing material attached to seal a space between seal lips of the inner weather strip.

### SUMMARY

However, the structure disclosed in JP 2001-301469 A is produced by pressing and attaching the sound-absorbing material, such as synthetic fiber felt, nonwoven fabric, or urethane foam rubber, for example, to a base part of the weather strip during extrusion molding of rubber, or by forming the weather strip by extrusion molding and then attaching the sound-absorbing material to the base part of the weather strip with an adhesive. Thus, the weather strip disclosed in JP 2001-301469 A includes the rubber weather strip having a base part and the sound-absorbing material made of a material other than rubber attached on the base part, and therefore has a complicated structure.

Embodiments of the disclosure are therefore aimed at reducing entrance of noise from outside the vehicle cabin to the vehicle cabin with a simple configuration.

In one aspect of the disclosure, a sound insulation structure is to be disposed in a space between vehicle components to reduce noise transmission through the space, and the space forms a propagation path of noise from outside a vehicle cabin into the vehicle cabin. The sound insulation structure includes a base, and a plurality of protrusions disposed on a surface of the base.

Sound waves entering a recess between the plurality of protrusions are reflected at the bottom of the recess to interfere with sound waves external to the protrusions. This configuration lowers the sound pressure level to thereby reduce entrance of noise from outside the vehicle cabin into the vehicle cabin.

In the sound insulation structure, the base may be part of a seal member to be attached to a first component of the vehicle components defining the space to seal the space, and the plurality of protrusions may be integral with the seal member.

The base and the protrusions are integrally formed, as described above. Entrance of noise from outside of the vehicle cabin into the vehicle cabin can therefore be reduced with a simple configuration.

In the sound insulation structure, the seal member may be a weather strip that is a longitudinal component to seal the space of the vehicle, and the seal member may include a body part to be attached to the first vehicle component defining the space, and seal lip rising on the body part to protrude toward a second vehicle component of the vehicle components defining the space and come into contact with the second vehicle component at tip of the seal lip. The base may be the body part of the weather strip, and the plurality of protrusions may protrude toward the second vehicle component and extend longitudinally.

As described above, it is possible to produce the protrusions protruding toward the second vehicle component and extending along the length of the weather strip which is a longitudinal component, at the time of producing the weather strip by extrusion molding of rubber. This configuration enables simple production of the protrusions for reducing entrance of noise into the vehicle cabin.

In the sound insulation structure, the weather strip may be a belt line weather strip to be attached to a door member to seal a space between the door member and a door glass, and may include at least two seal lips. The plurality of protrusions may be disposed on the body part between the seal lips.

This configuration lowers the sound pressure level in the space between the seal lips to thereby reduce entrance of the noise through the seal lips into the vehicle cabin.

In the sound insulation structure, the protrusions may be disposed on a first surface of each of the seal lips opposite a second surface that comes into contact with the second vehicle component.

This configuration can effectively lower the sound pressure level in the space between the seal lips to thereby reduce entrance of the noise through the seal lips into the vehicle cabin.

In the sound insulation structure, the protrusions may have a cross section having a wedge shape with a tapered tip.

The protrusions having a wedge shape cross section reflect sound waves entering between the protrusions repeatedly at the surfaces of opposing protrusions and thus attenuate the sound waves. Thus, entrance of noise from outside the vehicle cabin into the vehicle cabin is reduced with a simple configuration.

In the sound insulation structure, the protrusions may have a planar shape.

This enables reduction of entrance of noise from outside the vehicle cabin into the vehicle cabin with a simple configuration.

In the sound insulation structure, the protrusions may have a surface on which a sound-absorbing material is attached.

This configuration effectively reduces entrance of noise from outside the vehicle cabin into the vehicle cabin.

In a further aspect of the disclosure, a vehicle component is configured to define a space with a further vehicle component, and the space forms a propagation path of noise from outside a vehicle cabin into the vehicle cabin. The vehicle component includes a base part, and a plurality of protrusions rising on a surface of the base part to extend toward the further vehicle component to reduce transmission of noise through the space.

As described above, the plurality of protrusions disposed on a portion of the vehicle component opposite the further vehicle component reduce entrance of noise through the space between the vehicle component and the further vehicle component into the vehicle cabin.

In the vehicle component, the plurality of protrusions may be integral with the base part.

As described above, a simple configuration including the base part integral with the protrusions can reduce entrance of noise from outside the vehicle cabin into the vehicle cabin.

The present disclosure enables reduction in entrance of noise from outside the vehicle cabin into the vehicle cabin with a simple configuration.

### BRIEF DESCRIPTION OF DRAWINGS

Embodiments of the present disclosure will be described by reference to the following figures, wherein:

FIG. 1 is a perspective view illustrating a vehicle including a sound insulation structure or a vehicle component according to an embodiment;

FIG. 2 is a cross sectional view taken along A-A line in FIG. 1;

FIG. 3 is a perspective view illustrating an inner belt line weather strip according to the embodiment;

FIG. 4 is a cross sectional view of the inner belt line weather strip according to the embodiment, showing transmission and attenuation of sound by the inner belt line weather strip and an outer belt line weather strip;

FIG. 5 is a cross sectional view of protrusions, showing reflection and attenuation of sound that has entered a recess;

FIG. 6 is a cross sectional view of an inner belt line weather strip according to another embodiment;

FIG. 7 is a cross sectional view of an inner belt line weather strip according to a further embodiment;

FIG. 8 is a cross sectional view of an inner belt line weather strip according to another embodiment;

FIG. 9 is a cross sectional view taken along B-B line in FIG. 1;

FIG. 10 is an enlarged cross sectional view of a door weather strip illustrated in FIG. 9;

FIG. 11 is an enlarged cross sectional view of an opening weather strip illustrated in FIG. 9; and

FIG. 12 is a cross sectional view taken along C-C line in FIG. 1.

### DESCRIPTION OF EMBODIMENTS

Various weather strips to which sound insulation structures according to embodiments are applied will be described by reference to the drawings. In each drawing, arrows FR, UP, and LH indicate frontward (forward), upward, and leftward of a vehicle 10, respectively. The directions opposite the arrows FR, UP, and LH are rearward, downward, and rightward of the vehicle, respectively. In the following description, unless specified otherwise, simple description of front and rear, right and left (widthwise), and above and below refers to directions with regard to a vehicle.

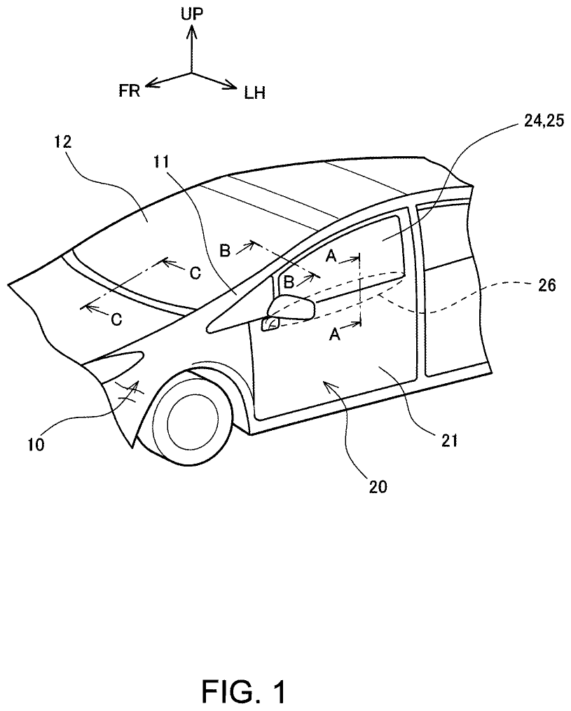

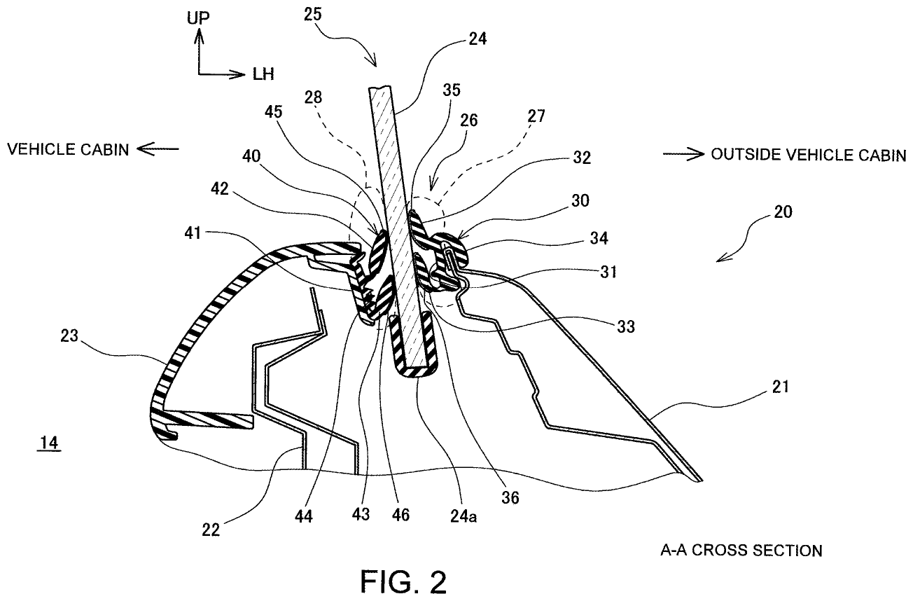

In the vehicle 10 illustrated in FIG. 1, an outer belt line weather strip 30 and an inner belt line weather strip 40 illustrated in FIG. 2 are attached to a belt line portion 26 on a lower side of a window opening 25 of a door 20.

As illustrated in FIG. 2, the door 20 includes a door outer panel 21, a door inner panel 22, and a door interior member 23 attached on a surface of the door inner panel 22 facing a vehicle cabin. The door outer panel 21, the door inner panel 22, and the door interior member 23 together form a door member. Above the door outer panel 21 and the door interior member 23 is the window opening 25 to which a door glass 24 is attached. The door glass 24 is connected, via a holding member 24a, to a drive mechanism to move upward and downward. The outer belt line weather strip 30 that is a seal member is disposed in a space 27 between the door outer panel 21 of the door 20 outward of the vehicle cabin and the door glass 24. The inner belt line weather strip 40 that is a seal member is further disposed in a space 28 between the door interior member 23 of the door 20 inward of the vehicle cabin and the door glass 24.

As will be described below, noise outside the vehicle cabin enters the vehicle cabin 14 through the space 28, or through the space 27 and the space 28. The outer belt line weather strip 30 and the inner belt line weather strip 40 are therefore disposed in the spaces 27 and 28, respectively, between components of the vehicle 10 forming a propagation path of noise from outside of the vehicle cabin to inside of the vehicle cabin.

The outer belt line weather strip 30 is a longitudinal component including a body part 31 to be attached to the door outer panel 21, an upper seal lip 32 and a lower seal lip 33 rising on the body part 31, and a belt molding 34 covering an upper end of the door outer panel 21. The upper seal lip 32 and the lower seal lip 33 each include a flock material 35, 36 on the undersurface facing the door glass 24. The upper seal lip 32 and the lower seal lip 33 protrude toward the door glass 24 to bring the flock materials 35 and 36 on tip ends into contact with the door glass 24, thereby sealing the space 27 between the door glass 24 and the door outer panel 21. The outer belt line weather strip 30 is a component produced by extrusion molding of rubber. The space 27 of the vehicle 10 is defined by two components: the door outer panel 21 to which the outer belt line weather strip 30 is to be attached and the door glass 24 with which the flock materials 35 and 36 on the tip ends of the upper seal lip 32 and the lower seal lip 33 come into contact. The body part 31 forms a base.

The inner belt line weather strip 40 is a longitudinal component including a body part 41 to be attached to the door interior member 23, an upper seal lip 42 and a lower seal lip 43 rising on the body part 41, and protrusions 44 having a wedge shape cross section. The upper seal lip 42 and the lower seal lip 43 protrude toward the door glass 24. The upper seal lip 42 and the lower seal lip 43 each include a flock material 45, 46 on the undersurfaces facing the door glass 24. The flock materials 45 and 46 on tip ends of the upper seal lip 42 and the lower seal lip 43 come into contact with the door glass 24 to seal the space 28 between the door glass 24 and the door interior member 23. The space 28 of vehicle 10 is defined by two components: the door interior member 23 to which the inner belt line weather strip 40 is to be attached and the door glass 24 with which the flock materials 45 and 46 on the tip ends of the upper seal lip 42 and the lower seal lip 43 come in contact. The body part 41 forms a base.

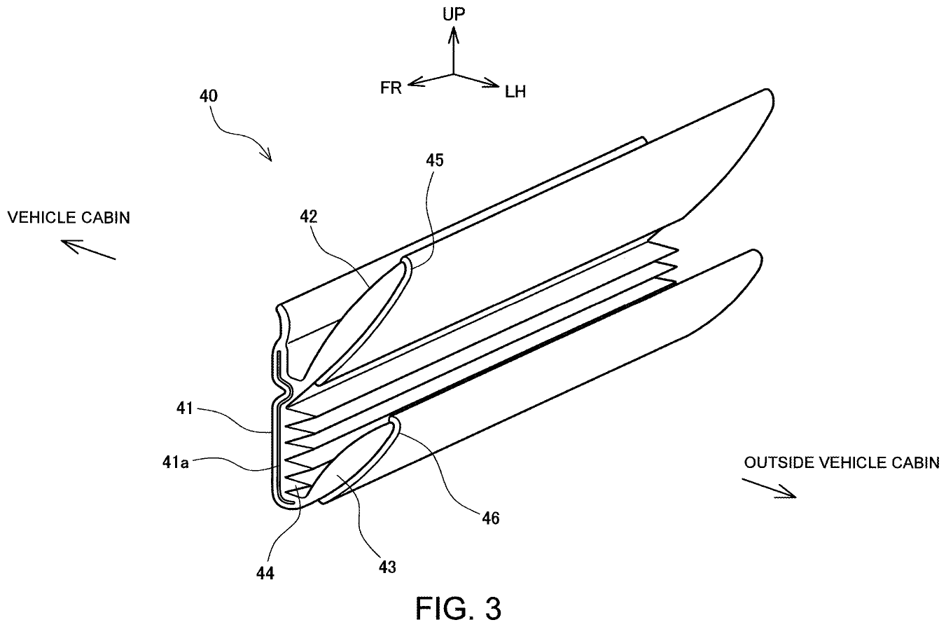

The inner belt line weather strip 40 is a longitudinal component produced by extrusion molding of rubber. As illustrated in FIG. 3, the protrusions 44 protrude toward the door glass 24 on the body part 41 between the upper seal lip 42 and the lower seal lip 43. Each protrusion 44 has a wedge shape cross section with a tip tapered toward the door glass 24. In the illustrated example, five protrusions are arranged vertically on the body part 41 between the upper seal lip 42 and the lower seal lip 43. The protrusions 44 are integral with the body part 41, the upper seal lip 42, and the lower seal lip 43, and extend longitudinally in parallel to the body part 41, the upper seal lip 42, and the lower seal lip 43. A plate member 41a is embedded in the body part 41 for reinforcement. The flock materials 45 and 46 are formed as follows. In a manufacturing step after the extrusion molding, an adhesive is applied to flock-forming regions of the upper seal lip 42 and the lower seal lip 43, and then wool material for the flock materials are dispersed over the flock-forming region, so that the wool materials are adhered and fixed to predetermined regions of the upper seal lip 42 and the lower seal lip 43.

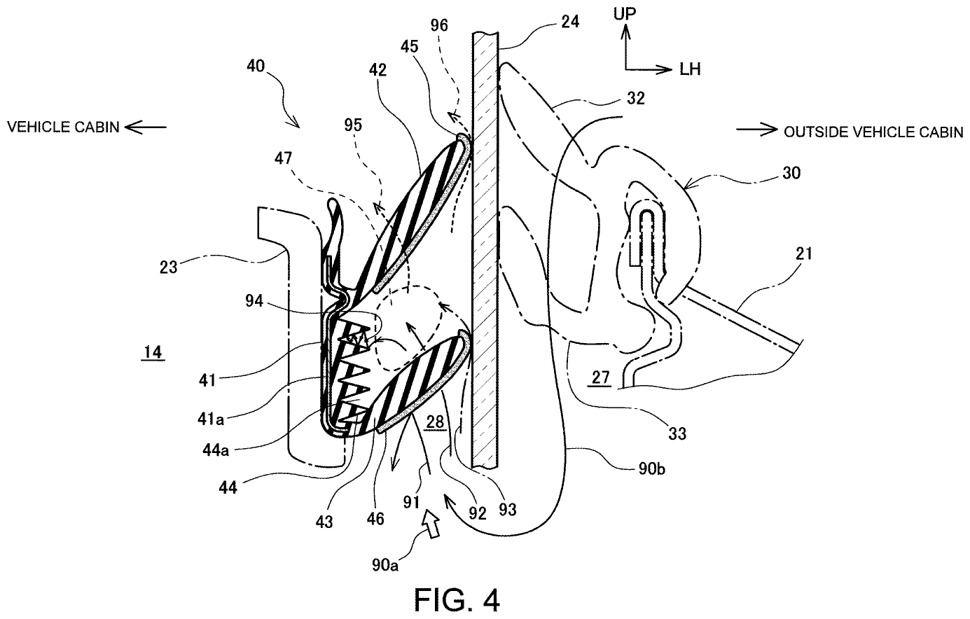

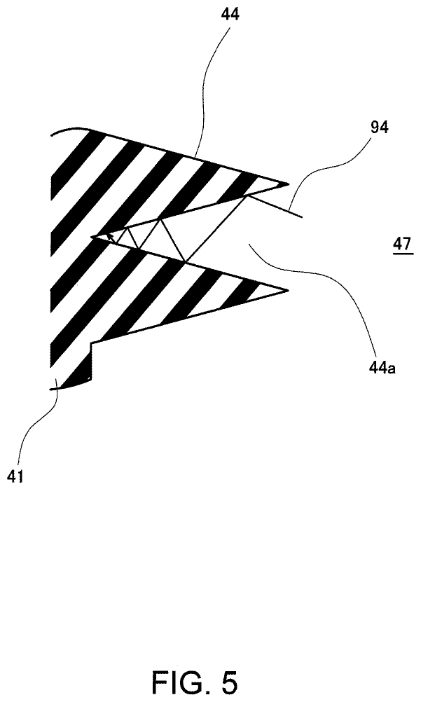

Referring now to FIGS. 4 and 5, the operation and advantages of the inner belt line weather strip 40 will be described.

Road noise generated between tires and a road surface enters a space between the door outer panel 21 and the door inner panel 22 (see FIG. 2) through a drain hole, for example, disposed in a lower part of the door 20 of the vehicle 10. The road noise further propagates upward through the space between the door outer panel 21 and the door inner panel 22 and reaches the space 28 between the door interior member 23 and the door glass 24, as indicated by a blank arrow 90a in FIG. 4. As indicated by an arrow 90b in FIG. 4, wind noise transmits, from outside the vehicle cabin, through the upper seal lip 32 and the lower seal lip 33 of the outer belt line weather strip 30 into the space 27 between the door outer panel 21 and the door glass 24, and reaches the space 28 between the door interior member 23 and the door glass 24 from under the door glass 24.

Part of the noise that has reached the space 28 is absorbed by the flock material 46 of the lower seal lip 43, while another part of the noise is reflected by the lower seal lip 43, as indicated by an arrow 91 in FIG. 4. Further part of the noise transmits through the lower seal lip 43 and enters a space 47 between the upper seal lip 42 and the lower seal lip 43, as indicated by an arrow 92 in FIG. 4. Another part of the noise further enters the space 47 from between the flock material 46 of the lower seal lip 43 and the door glass 24 as indicated by a dashed and single-dotted line arrow 93 in FIG. 4.

The space 47 is enclosed by the upper seal lip 42, the lower seal lip 43, the body part 41, and the door glass 24. As the space 47 is a closed region in which the sound waves are reflected repeatedly, the sound pressure level would increase in the space 47 unless any countermeasures are taken. In this embodiment, the inner belt line weather strip 40 includes the protrusions 44 on the body part 41 between the upper seal lip 42 and the lower seal lip 43. As illustrated in FIG. 5, the sound wave that has entered a recess 44a between the protrusions 44 proceeds further backward of the recess 44a while being repeatedly reflected on the surfaces of upper and lower protrusions 44, as indicated by an arrow 94 in FIG. 5. This reflection attenuates the sound wave that has entered the recess 44a, thereby reducing the sound pressure level in the space 47.

The sound wave entering the recess 44a of the protrusions 44, reflected on the bottom of the recess 44a, and then reflected from the protrusions 44 toward the space 47, interferes with a sound wave in the space 47 to thereby reduce the sound pressure level in the space 47.

As described above, the protrusions 44 reduce the sound pressure level in the space 47. Such a configuration of the protrusions 44 reduces the sound entering the vehicle cabin 14 from the space 47 through the upper seal lip 42 as indicated by a dashed line arrow 95 in FIG. 4 and the sound entering the vehicle cabin 14 through a space between the flock material 45 of the upper seal lip 42 and the door glass 24 as indicated by a dashed line arrow 96 in FIG. 4.

The protrusions 44 thus attenuate the sound entering the space 47 to reduce the sound pressure level of the space 47. This configuration regulates noise transmission through the space 28 between the door glass 24 and the door interior member 23 and reduces entrance of noise from outside the vehicle cabin into the vehicle cabin. Further, the protrusions 44, which are integral with the body part 41, the upper seal lip 42, and the lower seal lip 43, reduce entrance of the noise from outside the vehicle cabin to the vehicle cabin with a simple configuration. While in the above example, the inner belt line weather strip 40 is an extrusion molded rubber component, the inner belt line weather strip 40 may be formed by any other molding methods in which the protrusions 44 are integrally formed with the body part 41, the upper seal lip 42, and the lower seal lip 43, with any materials other than rubber, such as a resin.

A drive mechanism for the door glass 24 may be configured to press the door glass 24 in a full open state outward of the vehicle cabin. This configuration reduces a contact pressure between the door glass 24 and each of the flock materials 45 and 46 of the upper seal lip 42 and the lower seal lip 43 of the inner belt line weather strip 40, making noise likely to enter the vehicle cabin through the space between the door glass 24 and each of the flock materials 45 and 46 of the upper seal lip 42 and the lower seal lip 43. In this embodiment, the protrusions 44 of the inner belt line weather strip 40 reduce the sound pressure level in the space 47 between the upper seal lip 42 and the lower seal lip 43 to thereby reduce noise transmission through the space 28 and reduce entrance of noise from outside the vehicle cabin to the vehicle cabin.

While in the embodiment described above, the protrusions 44 of the inner belt line weather strip 40 include five protrusions arranged vertically on the body part 41 between the upper seal lip 42 and the lower seal lip 43, the number of protrusions in the protrusions 44 may be any number that is two or greater, such as two or three. The height or width of the protrusions 44 may also be modified in accordance with the frequency to be reduced.

While in the above embodiment, the inner belt line weather strip 40 includes two seal lips: that is, the upper seal lip 42 and the lower seal lip 43, the number of seal lips may be any plural number other than two, such as three or four, for example. In this configuration, the inner belt line weather strip 40 may be configured to include a plurality of protrusions 44 between each pair of seal lips.

While in the above embodiment, the inner belt line weather strip 40 is attached to the door interior member 23, the inner belt line weather strip 40 may be attached to the door inner panel 22.

While in the embodiment described above, the protrusions 44 are disposed on the body part 41 of the inner belt line weather strip 40, protrusions having the same configuration may be disposed on the body part 31 of the outer belt line weather strip 30.

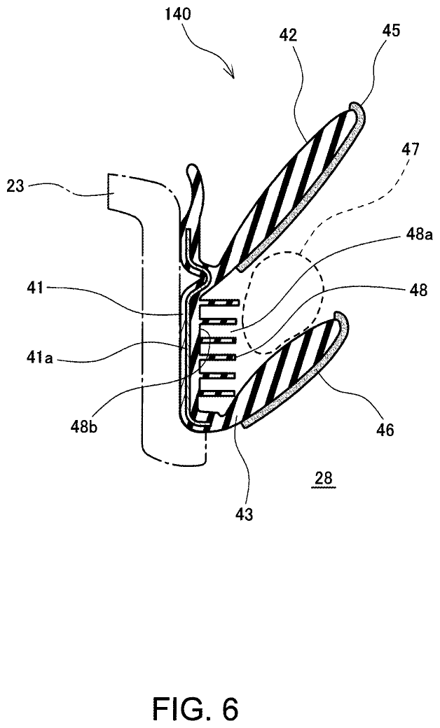

Referring now to FIG. 6, an inner belt line weather strip 140 according to another embodiment will be described. In the following description, elements identical with those of the inner belt line weather strip 40 described above with reference to FIG. 1 to FIG. 5 are denoted with the same reference numerals and will not be further described.

The inner belt line weather strip 140 illustrated in FIG. 6 includes flat protrusions 48 having a planar cross section, in place of the protrusions 44 having a wedge shape cross section of the inner belt line weather strip 40 described above with reference to FIG. 1 to FIG. 5.

A sound wave that has entered a slit 48a between the flat protrusions 48 from the space 47 between the upper seal lip 42 and the lower seal lip 43 of the inner belt line weather strip 140 is reflected at a bottom face 48b of the slit 48a and returns to the space 47 to interfere with the sound wave in the space 47, thereby reducing the sound pressure level in the space 47. This configuration reduces noise transmission through the space 28 to reduce entrance of noise from outside the vehicle cabin to the vehicle cabin.

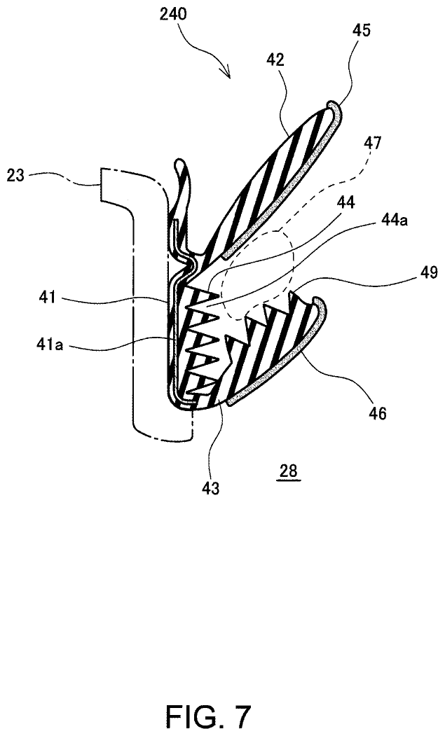

Referring now to FIG. 7, a configuration of an inner belt line weather strip 240 according to a further embodiment will be described. Elements which are identical with those of the inner belt line weather strip 40 described above by reference to FIG. 1 to FIG. 5 are denoted with the same reference numerals and will not be further described.

As illustrated in FIG. 7, the inner belt line weather strip 240 includes a plurality of protrusions 49 on a top surface of the lower seal lip 43 of the inner belt line weather strip 40 described above by reference to FIG. 1 to FIG. 5. The protrusions 49 protrude toward the space 47 between the upper seal lip 42 and the lower seal lip 43. The top surface of the lower seal lip 43 is opposite the undersurface of the lower seal lip 43 on which the flock material 46 is formed and which comes into contact with the door glass 24. Further, the body part 41 and the lower seal lip 43 of the inner belt line weather strip 240 form bases on which the protrusions 44 and the protrusions 49 are respectively disposed.

The inner belt line weather strip 240 according to this embodiment includes a great number of protrusions 44 and 49, and therefore significantly reduces the sound pressure level of the space 47. This configuration further enables reduced noise transmission through the space 28 to thereby reduce entry of noise from outside the vehicle cabin into the vehicle cabin.

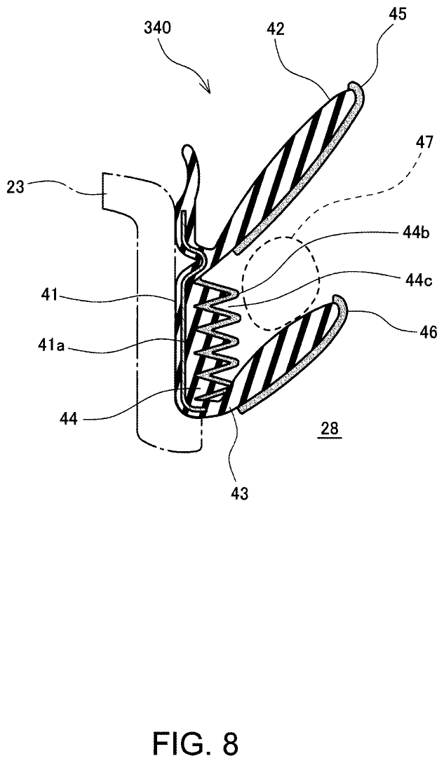

Referring further to FIG. 8, an inner belt line weather strip 340 according to a further embodiment will be described. Elements which are identical with those of the inner belt line weather strip 40 described above by reference to FIG. 1 to FIG. 5 are denoted with the same reference numerals and will not be further described

As illustrated in FIG. 8, the inner belt line weather strip 340 includes a flock material 44b which is a sound-absorbing material on a top surface of the protrusions 44 of the inner belt line weather strip 40 described above by reference to FIG. 1 to FIG. 5. Similar to the flock materials 45 and 46, the flock material 44b may be formed by applying an adhesive to the surface of the protrusions 44 and dispersing a wool material for the flock material over the surface for attaching the wool material to the surface, at a manufacturing stage after the extrusion molding.

The inner belt line weather strip 340 of this embodiment absorbs sound entering recesses 44c of the flock material 44b with the flock material 44b to thereby significantly reduce the sound pressure level of the space 47 between the upper seal lip 42 and the lower seal lip 43. This configuration reduces noise transmission through the space 28 to thereby enable reduced entrance of noise from outside the vehicle cabin into the vehicle cabin. While in this embodiment, the inner belt line weather strip 340 includes, as a sound-absorbing material, the flock material 44b, the sound-absorbing material is not limited to a flock material and may be felt, unwoven fabric, or urethane, for example, attached to the surface of the protrusions 44 with an adhesive.

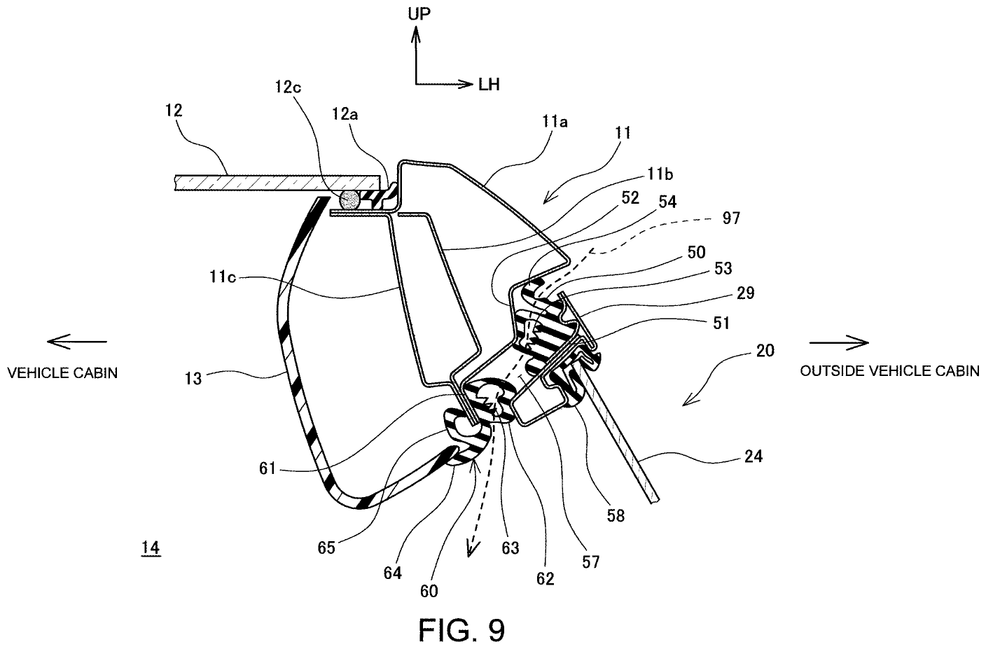

Referring further to FIG. 9 to FIG. 11, a further weather strip will be described. As illustrated in FIG. 9, a door weather strip 50 and an opening weather strip 60 are attached between a front pillar 11 and the door 20 of the vehicle 10 illustrated in FIG. 1. The door weather strip 50 is a seal member attached to a front window frame 29 of the door 20 to seal a space 57 between the front window frame 29 and a pillar outer panel 11a of the front pillar 11. The opening weather strip 60 is a seal member attached to the front pillar 11 to seal the space 57 between the front pillar 11 and the front window frame 29 of the door 20. A windshield glass 12 is attached to the front pillar 11 via a glass adhesive 12c and a seal member 12a, and an interior trim 13 is mounted within the vehicle cabin. The door glass 24 is attached to the door 20 via a seal member 58. FIG. 9 illustrates seal lips 52 and 62 of the door weather strip 50 and the opening weather strip 60, respectively, in a collapsed state with the door 20 being closed.

As indicate by a dashed line arrow 97 in FIG. 9, noise outside of the vehicle cabin enters the vehicle cabin through the space 57. The door weather strip 50 and the opening weather strip 60 are therefore disposed in the space 57 between components of the vehicle 10 forming a propagation path of noise from outside the vehicle cabin into the vehicle cabin.

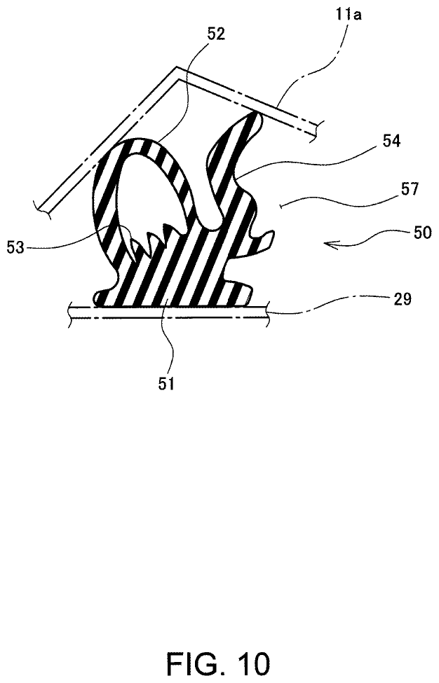

FIG. 10 is a cross sectional view illustrating the door weather strip 50 with the seal lip 52 being uncollapsed. As illustrated in FIG. 10, the door weather strip 50 is a longitudinal component including a body part 51 to be attached to the front window frame 29 of the door 20, the tubular seal lip 52 formed on the body part 51, protrusions 53 having a wedge shape cross section and formed on the body part 51, and an outer seal lip 54 extending from the body part 51 toward the pillar outer panel 11a. The seal lip 52 protrudes toward the pillar outer panel 11a with its tip end coming into contact with the pillar outer panel 11a to seal the space 57 between the front window frame 29 of the door 20 and the pillar outer panel 11a. The protrusions 53 protrude from the body part 51 into the seal lip 52. The space 57 of the vehicle 10 is defined by two components: the front window frame 29 to which the door weather strip 50 is to be attached and the pillar outer panel 11a with which the tip end of the seal lip 52 comes into contact. The body part 51 forms a base. Similar to the inner belt line weather strip 40 described above by reference to FIG. 1 to FIG. 5, the door weather strip 50 is also a longitudinal component produced by extrusion molding of rubber, and the protrusions 53 are integral with the body part 51, the seal lip 52, and the outer seal lip 54.

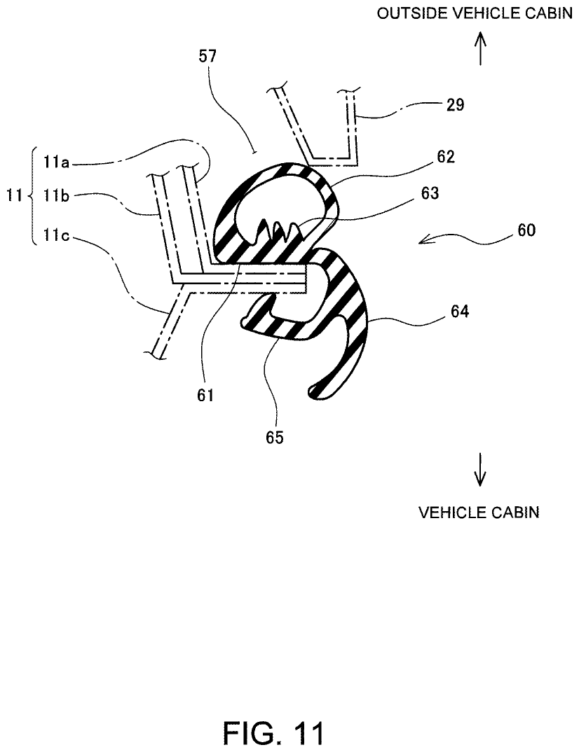

FIG. 11 is a cross sectional view illustrating the opening weather strip 60 with the seal lip 62 being uncollapsed. The opening weather strip 60 includes a body part 61 to be attached to a portion of the front pillar 11 where the pillar outer panel 11a and pillar inner panels 11b and 11c are superposed, the tubular seal lip 62 formed on the body part 61, protrusions 63 on the body part 61, an inner seal lip 64 extending inward of the vehicle cabin from the body part 61, and a fix lip 65 that clips the portion of the front pillar 11 where the pillar outer panel 11a and the pillar inner panels 11b and 11c are superposed from inside of the vehicle cabin. The seal lip 62 protrudes toward the front window frame 29 with its tip end coming into contact with the front window frame 29 to seal the space 57 between the front window frame 29 and the front pillar 11. The protrusions 63 protrude from the body part 61 into the seal lip 62. The space 57 of the vehicle 10 is defined by two components: the front pillar 11 to which the opening weather strip 60 is to be attached and the front window frame 29 with which the tip end of the seal lip 62 comes into contact. The body part 61 forms a base. Similar to the inner belt line weather strip 40 described above by reference to FIG. 1 to FIG. 5, the opening weather strip 60 is also a longitudinal component produced by extrusion molding of rubber, and the protrusions 63 are integral with the body part 61, the seal lip 62, the inner seal lip 64, and the fix lip 65.

The door weather strip 50 and the opening weather strip 60 attenuate the sound pressure of the sound that has entered the tubular seal lips 52 and 62, with the protrusions 53 and 63, respectively, to thereby reduce the sound pressure level of the seal lips 52 and 62. This configuration enables reduction in noise transmission through the space 57 to reduce entrance of the noise from outside the vehicle cabin into the vehicle cabin.

As described above, the inner belt line weather strip 40, the door weather strip 50, and the opening weather strip 60 including the body parts 41, 51, 61, the seal lips 42, 43, 52, 62, and the protrusions 44, 48, 49, 53, 63 which are distinct from the seal lips 42, 43, 52, 62, respectively, are described as example sound insulation structures, by reference to FIG. 1 to FIG. 11. However, the sound insulation structure is not limited to these examples.

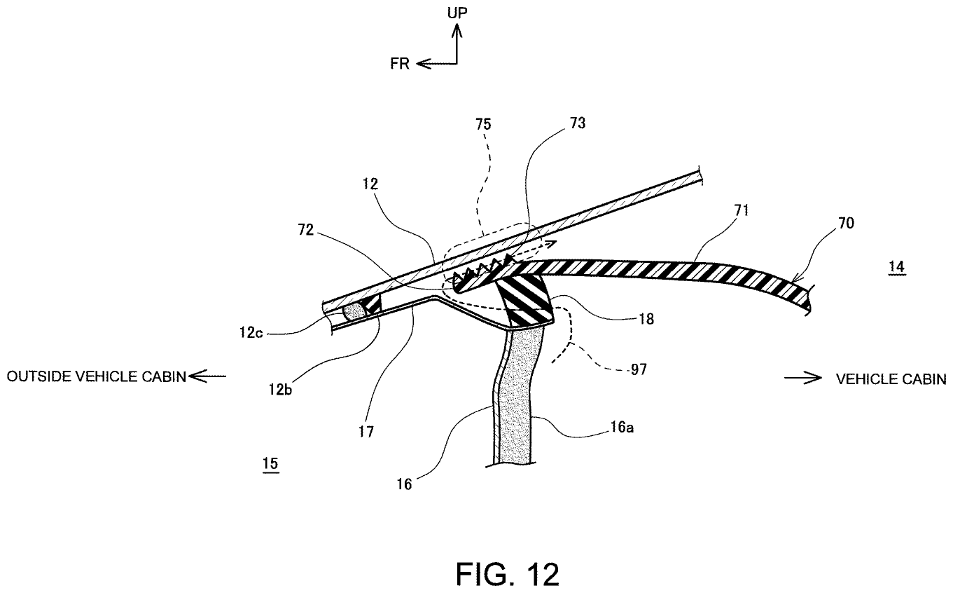

For example, the inner belt line weather strip 40 described above by reference to FIG. 1 to FIG. 3 may include only the body part 41 and the protrusions 44 without the seal lips 42 and 43. The sound insulation structure having this configuration is to be disposed in a space which no rainwater enters but forms a propagation path of noise into the vehicle cabin. This example will be described below by reference to FIG. 12.

Referring to FIG. 12, an instrument panel 70 that is a vehicle component according to an embodiment will be described. The instrument panel 70 is an interior member disposed in the front of the vehicle cabin 14 and including meters such as a speedmeter and an air blowoff port, for example. As illustrated in FIG. 12, a dash panel 16 that separates a front compartment 15 housing a power train and the vehicle cabin 14 is disposed in the front of the vehicle cabin 14. A sound insulation material 16a is attached to a surface of the dash panel 16 facing the vehicle cabin 14. The dash panel 16 is connected, on its upper end with an upper panel 17 that receives the windshield glass 12. Specifically, the windshield glass 12 is attached over the upper panel 17 via a glass adhesive 12c and a seal member 12b. The instrument panel 70 is attached, at its front end 72 of a base part 71, to a top surface of the upper panel 17 via a seal member 18. An upper surface of the front end 72 of the base part 71 and a lower surface of the windshield glass 12 are opposed to each other and define a space 75 between these surfaces.

The upper surface of the front end 72 of the instrument panel 70 is formed into a plurality of protrusions 73 having a wedge cross section protruding into the space 75 toward the windshield glass 12. The protrusions 73 are formed from the same resin as the instrument panel 70 and are integrally formed with the instrument panel 70 during manufacturing by resin molding.

Noise generated in the front compartment 15 enters through the dash panel 16 into the interior of the instrument panel 70. The noise entering the interior of the instrument panel 70 transmits through the seal member 18 and is propagated through the space 75 between the upper surface of the front end 72 of the base part 71 and the lower surface of the windshield glass 12 into the vehicle cabin 14. Thus, the instrument panel 70 is a vehicle component that defines, with another component; that is, the windshield glass 12, the space 75 forming a propagation path of the noise from the outside the vehicle cabin into the vehicle cabin.

Similar to the protrusions 44 of the inner belt line weather strip 40 described above by reference to FIG. 1 to FIG. 5, the protrusions 73 also attenuate the sound entering the space 75 to thereby reduce the sound pressure level of the space 75. This enables reduction in noise transmission through the space 75 to reduce entrance of the noise from outside the vehicle cabin into the vehicle cabin.

While in the above example, the protrusions 73 are disposed on the instrument panel 70, the protrusions 73 may be disposed on other interior components produced by resin molding. Further, while in the above example, the front end 72 of the base part 71 of the instrument panel 70 is attached, via the seal member 18, to the top face of the upper panel 17, the front end 72 of the base part 71 of the instrument panel 70 may be attached directly to the upper panel 17.

Further, while in the above example, the instrument panel 70 itself includes the protrusions 73, a sound insulation structure including only the body part 41 and the protrusions 44 of the inner belt line weather strip 40 described above by reference to FIG. 1 to FIG. 3 and including no seal lips 42 and 43 may be attached to the top face of the front end 72 of the instrument panel 70 such that the protrusions 44 protrude toward the windshield glass 12. Alternatively, a sound insulation structure including the body part 41 and the protrusions 44 may be attached to the lower surface of the windshield glass 12 such that the protrusions 44 protrude toward the instrument panel 70. In this configuration, the space 75 of the vehicle is defined by two components: the instrument panel 70 and the windshield glass 12.

In the embodiments described above, the protrusions 44, 53, 63, and 73 of the inner belt line weather strip 40, the door weather strip 50, the opening weather strip 60, and the instrument panel 70, respectively, are integral with and made of the same material as the respective body parts 41, 51, and 61 or the base part 71. This simple configuration enables reduction in entrance of the noise from the outside the vehicle cabin into the vehicle cabin with reduced costs.

1. A sound insulation structure to be disposed in a space between vehicle components to reduce noise transmission through the space, the space forming a propagation path of noise from outside a vehicle cabin into the vehicle cabin,
the sound insulation structure comprising:
a base; and
a plurality of protrusions disposed on a surface of the base.

2. The sound insulation structure according to claim 1, wherein
the base is part of a seal member to be attached to a first vehicle component of the vehicle components defining the space to seal the space, and
the plurality of protrusions are integral with the seal member.

3. The sound insulation structure according to claim 2, wherein
the seal member is a weather strip that is a longitudinal component to seal the space, the seal member comprising a body part to be attached to the first vehicle component defining the space, and seal lip rising on the body part to protrude toward a second vehicle component of the vehicle components defining the space and come into contact with the second vehicle component at tip of the seal lip,
the base is the body part of the weather strip, and
the plurality of protrusions protrude toward the second vehicle component and extend longitudinally.

4. The sound insulation structure according to claim 3, wherein
the weather strip is a belt line weather strip to be attached to a door member to seal a space between the door member and a door glass, the weather strip comprising at least two seal lips, and
the plurality of protrusions are disposed on the body part between the seal lips.

5. The sound insulation structure according to claim 4, wherein
the protrusions are disposed on a first surface of each of the seal lips opposite a second surface that comes into contact with the second vehicle component.

6. The sound insulation structure according to claim 1, wherein
the protrusions have a cross section having a wedge shape with a tapered tip.

7. The sound insulation structure according to claim 1, wherein
the protrusions have a planar shape.

8. The sound insulation structure according to claim 1, wherein
the protrusions have a surface on which a sound-absorbing material is attached.

9. A vehicle component configured to define a space with a further vehicle component, the space forming a propagation path of noise from outside a vehicle cabin into the vehicle cabin,
the vehicle component comprising:
a base part; and
a plurality of protrusions rising on a surface of the base part to extend toward the further vehicle component to reduce transmission of noise through the space.

10. The vehicle component according to claim 9, wherein
the protrusions are integral with the base part.
